(19) United States
(12) Patent Application Publication
(10) Pub. No.: US 2013/0110689 A1
(43) Pub. Date: May 2, 2013

(54) SALES MANAGEMENT SYSTEM, METHOD OF MANAGING SALES, PROGRAM, AND RECORDING MEDIUM

(71) Applicant: Yoshinori Kobayashi, Shinagawa-ku (JP)

(72) Inventor: Yoshinori Kobayashi, Shinagawa-ku (JP)

(73) Assignee: RAKUTEN, INC., Shinagawa-ku, Tokyo (JP)

(21) Appl. No.: 13/807,853

(22) PCT Filed: Jun. 30, 2011
(86) PCT No.: PCT/JP2011/065021

§ 371 Date: Dec. 31, 2012

(30) Foreign Application Priority Data
Jun. 30, 2010 (JP) 2010-150623

(51) Int. Cl. G06Q 40/00

(52) U.S. Cl. CPC G06Q 40/10
USPC 705/34

(57) ABSTRACT

A sales statement information storage section (34) stores sales statement information representing a sale by use of a credit card held by a user. A user identification section (38) identifies the user based on data received from a user terminal. An amount of payment correction section (48) refers to an access history storage section for storing access history to a predetermined site so as to correct to reduce, under the condition that it is determined that the access history to the predetermined site by the user identified by the user identification section (38) is stored in the access history storage section, an amount of money to be paid subsequently by the user in the sales statement information. A statement page generation section (40) generates, based on the sales statement information after the correction, a sales statement page describing an amount of money to be charged to the user. A statement page transmission section (42) transmits the generated sales statement page to the user terminal. Therefore, it is capable of correcting an amount of money to be subsequently paid by a user under the condition that the user simply makes an access to a predetermined site.

### TECHNICAL FIELD

The present invention relates to a sales management system, a method of managing sales, a program, and a recording medium.

### BACKGROUND ART

In recent years, shop introduction business of providing information on real shops such as restaurants by using the Internet has been prevailing. Shop introduction systems used in the shop introduction business include a system for providing a user with Web pages including coupons available for shops. The user using this shop introduction system can print a Web page including a coupon, and can receive a discount service by bringing the coupon to a shop.

Moreover, in recent years, mail-order business using the Internet has been deployed. Mail-order systems used for the mail-order business include a system which discounts an amount of money of purchase when a user purchases articles, and the system receives a coupon code which the user is notified of by an electronic mail or the like.

Moreover, there is a system for supporting credit card settlement in the mail-order business by using the Internet. Patent Literature 1 discloses a technology for registering a discount amount of money based on an amount of payment in a case where the amount of payment by a credit card exceeds a predetermined amount of money, a case where a lump-sum payment method is selected, and other such cases.

### CITATION LIST

### Patent Literature

[Patent Literature 1] JP 11-149503 A

### SUMMARY OF INVENTION

### Technical Problem

However, according to the conventional technology, by a user simply making an access to a predetermined site such as a site in which a Web page including a coupon exists, an amount of payment to be subsequently paid by the user is not corrected, for example, not reduced.

The present invention has been made in view of the above-mentioned problem, and therefore has an object to correct an amount of money to be subsequently paid by a user when the user simply makes an access to a predetermined site.

### Solution to Problem

In order to solve the above-mentioned problem, according to the present invention, there is provided a sales management system, including: sales statement information storage means for storing sales statement information representing a sale by use of a credit card held by a user; user identification means for identifying the user based on data received from a user terminal; amount of payment correction means for correcting, under the condition that it is determined that access history to a predetermined site by the user identified by the user identification means is stored in access history storage means for storing the access history to the predetermined site, an amount of money to be paid subsequently by the user in the sales statement information; statement page generation means for generating, based on the sales statement information after the correction by the amount of payment correction means, a sales statement page describing an amount of money to be charged to the user; and statement page transmission means for transmitting the sales statement page generated by the statement page generation means to the user terminal.

Further, according to the present invention, there is provided a method of managing sales, including: a step of storing sales statement information representing a sale by use of a credit card held by a user to sales statement information storage means; a user identification step of identifying the user based on data received from a user terminal; an amount of payment correction step of correcting, under the condition that it is determined that access history to a predetermined site by the user identified in the user identification step is stored in access history storage means for storing the access history to the predetermined site, an amount of money to be paid subsequently by the user in the sales statement information; a statement page generation step of generating, based on the sales statement information after the correction in the amount of money correction step, a sales statement page describing an amount of money to be charged to the user; and a statement page transmission step of transmitting the sales statement page generated in the statement page generation step to the user terminal.

Further, according to the present invention, there is provided a program for causing a computer to function as: means for storing sales statement information representing a sale by use of a credit card held by a user to sales statement information storage means; user identification means for identifying the user based on data received from a user terminal; amount of payment correction means for correcting, under the condition that it is determined that access history to a predetermined site by the user identified by the user identification means is stored in access history storage means for storing the access history to the predetermined site, an amount of money to be paid subsequently by the user in the sales statement information; statement page generation means for generating, based on the sales statement information after the correction by the amount of payment correction means, a sales statement page describing an amount of money to be charged to the user; and statement page transmission means for transmitting the sales statement page generated by the statement page generation means to the user terminal.

Further, according to the present invention, there is provided a recording medium having recorded thereon a program for causing a computer to function as: means for storing sales statement information representing a sale by use of a credit card held by a user to sales statement information storage means; user identification means for identifying the user based on data received from a user terminal; amount of payment correction means for correcting, under the condition that it is determined that access history to a predetermined site by the user identified by the user identification means is stored in access history storage means for storing the access history to the predetermined site, an amount of money to be paid subsequently by the user in the sales statement information; statement page generation means for generating, based on the sales statement information after the correction by the amount of payment correction means, a sales statement page describing an amount of money to be charged to the user; and statement page transmission means for transmitting the sales statement page generated by the statement page generation means to the user terminal.

In an aspect of the present invention, the amount of payment correction means corrects, under the condition that it is determined that the access history to the predetermined site by the user identified by the user identification means is stored in the access history stored in the access history storage means, and a correction request for the amount of money to be paid is received from the user terminal, the amount of money to be paid subsequently by the user in the sales statement information.

Further, in an aspect of the present invention, the amount of payment correction means corrects, under the condition that it is determined that the user identified by the user identification means, after using the credit card, has made an access to the predetermined site, the amount of money to be paid subsequently by the user in the sales statement information.

Further, in an aspect of the present invention, the amount of payment correction means corrects, under the condition that it is determined that the user identified by the user identification means, before using the credit card, has made an access to the predetermined site, the amount of money to be paid subsequently by the user in the sales statement information.

Further, in an aspect of the present invention, the amount of payment correction means corrects, by an amount of money determined based on a time of the access to the predetermined site by the user, the amount of money to be paid subsequently by the user in the sales statement information.

Further, in an aspect of the present invention, the corrected amount of money to be paid subsequently decreases as the time of the access to the predetermined site by the user becomes later.

Further, in an aspect of the present invention, the predetermined site is associated with a discount rate or a discount amount, and the amount of payment correction means corrects to reduce, based on the discount rate or the discount amount associated with the predetermined site to which it is determined that the access history by the user identified by the user identification means is stored, the amount of money to be paid subsequently by the user.

### Advantageous Effects of Invention

According to the present invention, under the condition that it is determined that the user who has used the credit card makes an access to the predetermined site, the amount of payment is corrected, and hence the amount of money to be subsequently paid by the user is corrected simply by the user making an access to the predetermined site.

### BRIEF DESCRIPTION OF DRAWINGS

FIG. 1 is an overall configuration diagram of a computer network according to an embodiment of the present invention.

FIG. 2 is a diagram illustrating an example of a coupon code display page.

FIG. 3 is a diagram illustrating an example of access history information.

FIG. 4 is a functional block diagram illustrating an example of functions achieved by a sales management system according to the embodiment.

FIG. 5 is a diagram illustrating an example of user management data.

FIG. 6 is a diagram illustrating an example of sales statement information.

FIG. 7 is a flowchart illustrating an example of a flow of sales statement information correction processing executed by the sales management system according to the embodiment.

FIG. 8 is a diagram illustrating an example of a sales statement page.

FIG. 9 is a diagram illustrating an example of a coupon code input page.

FIG. 10 is a diagram illustrating an example of the sales statement information after correction.

FIG. 11 is a diagram illustrating an example of the sales statement page after correction.

### DESCRIPTION OF EMBODIMENT

A detailed description is now given of an embodiment of the present invention referring to the drawings.

FIG. 1 is an overall configuration diagram of a computer network according to an embodiment of the present invention. As illustrated in FIG. 1, to a computer network 18 such as the Internet, a sales management system 10, a shop introduction system 12, shop terminals 14 (14-1 to 14-m), and user terminals 16 (16-1 to 16-n), any one of which is constructed mainly by a computer, are connected. Then, the sales management system 10, the shop introduction system 12, the shop terminals 14, and the user terminals 16 can communicate to/from each other.

The sales management system 10 is a computer system such as a Web application server for managing, for example, usage history of a user using a credit card. The shop introduction system 12 is a computer system such as a Web application server for providing, for example, a user with information on shops accepting credit cards. The shop introduction system 12 according to this embodiment presents, to a user, information representing a coupon providing a discount service for an amount of payment by a credit card.

Each of the sales management system 10 and the shop introduction system 12 includes, for example, a control unit which is a program-controlled device such as a CPU operating in accordance with a program installed on the each of the sales management system 10 and the shop introduction system 12, a storage unit which is a memory device such a ROM or a RAM, or a hard disk drive, and a communication unit which is a communication interface such as a network board. Those components are connected to each other via a bus. The storage units of the sales management system 10 and the shop introduction system 12 store programs executed by the control units of the sales management system 10 and the shop introduction system 12. Moreover, the storage units of the sales management system 10 and the shop introduction system 12 also operate as work memories for the sales management system 10 and the shop introduction system 12.

The shop terminal 14 is, for example, a computer installed in a shop such as a restaurant where a user uses a credit card, and the user terminal 16 is a computer used by a user of the sales management system 10. Each of the shop terminal 14 and the user terminal 16 includes, for example, a well-known personal computer provided with a control device such as a CPU, a storage device such as a memory device such as a ROM and a RAM, or a hard disk drive, an output device such as a display, an input device such as a mouse and a keyboard, and a communication device such as a network board. Moreover, in the user terminal 16 according to this embodiment, a Web browser and an electronic mail client are installed in advance, and those application programs are executed. The user terminal 16 receives, via the Web browser, various services provided by the sales management system 10 and the shop introduction system 12, and receives, via the electronic mail client, electronic mails transmitted by the sales management system 10 and the shop introduction system 12.

According to this embodiment, the shop terminal 14 includes a credit card reading device such as a CAT terminal for reading, for example, contents of a credit card held by a user who uses a shop.

According to this embodiment, under the condition that the user terminal 16 makes an access, via the Web browser, to the sales management system 10 or the shop introduction system 12, inputs a user ID and a password, and then makes an access to a predetermined URL, a screen corresponding to the predetermined URL is displaced on the display of the user terminal 16. Note that, after the user ID and the password are entered, the sales management system 10 and the shop introduction system 12 can identify the user ID of a user using the user terminal 16, for example, by referring to a cookie.

The shop terminal 14 transmits to the sales management system 10 sales data representing usage history (sales history) of a credit card held by a user in a shop in which the sale terminal 14 is provided. Then, the sales management system 10 receives the sales data from the shop terminal 14. The shop terminal 14 may transmit, for example, under the condition that a payment is made by a user using a credit card in a shop in which the shop terminal 14 is installed, sales data corresponding to the payment to the sales management system 10. Moreover, the shop terminal 14 may transmit to the sales management system 10, for example, every predetermined time, sales data representing sales which have been generated before in a shop in which the shop terminal 14 is installed up to the current time.

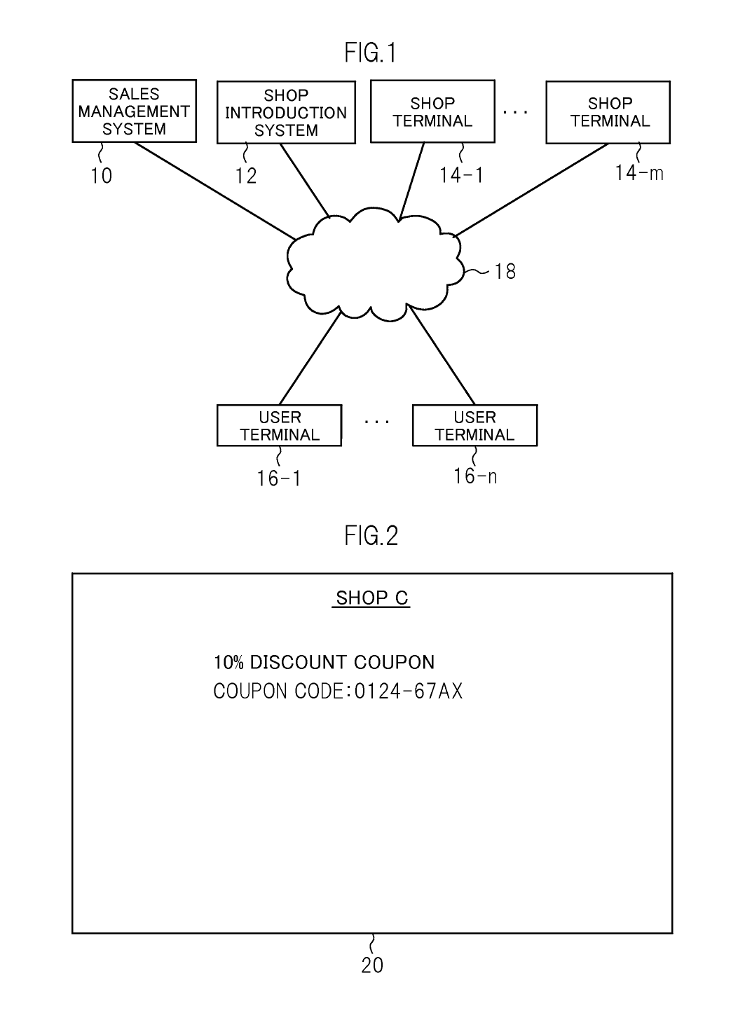

The shop introduction system 12 transmits, in response to a request from the user terminal 16, data representing a Web page introducing a shop to the user terminal 16. Then, the user terminal 16 outputs the page for display on the display. The shop introduction system 12 transmits, for example, in response to a request from the user terminal 16, data representing a coupon code display page 20 illustrated in FIG. 2 to the user terminal 16. Then, the user terminal 16 outputs the coupon code display page 20 for display on the display. The coupon code display page 20 includes, for example, a discount rate or a discount amount (in the example of FIG. 2, a discount rate of 10%) as a result of a purchase of an article or a use of a service in a predetermined shop (shop C), and a coupon code which is an identification mark for a discount coupon corresponding to the shop. The user can receive, by using this coupon code, a discount service for an amount of money paid by a credit card.

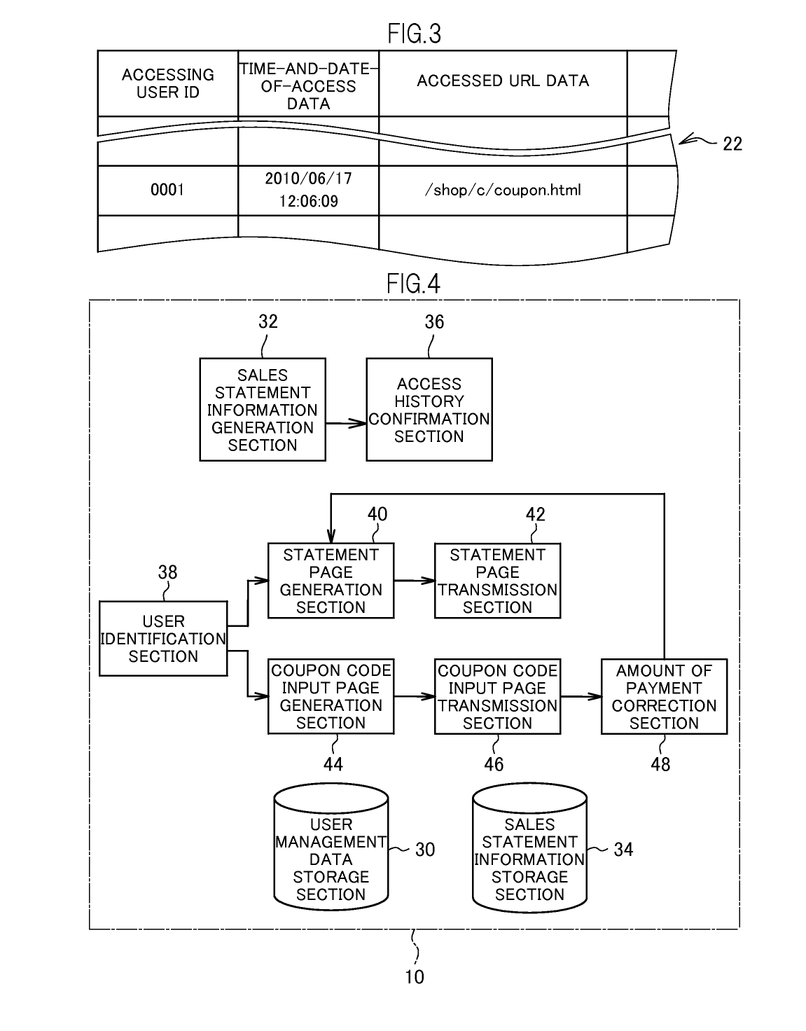

The storage unit of the shop introduction system 12 according to this embodiment functions as an access history storage section for storing access history information 22 (refer to FIG. 3) representing access history to sites (such as access history to a Web page) of the shop introduction system 12. The access history information 22 includes, for example, an accessing user ID which is an identifier of a user who has made an access to a Web page, time-and-date-of-access data representing a time and a date of an access to the Web page, and accessed URL data representing an accessed URL.

A description is now given of functions achieved by the sales management system 10 according to this embodiment. FIG. 4 is a functional block diagram illustrating an example of the functions achieved by the sales management system 10 according to this embodiment.

As exemplified in FIG. 4, the sales management system 10 includes a user management data storage section 30, a sales statement information generation section 32, a sales statement information storage section 34, an access history confirmation section 36, a user identification section 38, a statement page generation section 40, a statement page transmission section 42, a coupon code input page generation section 44, a coupon code input page transmission section 46, and an amount of payment correction section 48. The user management data storage section 30 and the sales statement information storage section 34 are implemented mainly by the storage unit of the sales management system 10. The other components are implemented mainly by the control unit of the sales management system 10.

Those elements are implemented by executing programs installed on the sales management system 10, which is a computer, by the control unit of the sales management system 10. Note that, the program is provided, via a computer-readable information recording medium such as a CD-ROM and a DVD-ROM, or via a communication network such as the Internet, to the sales management system 10.

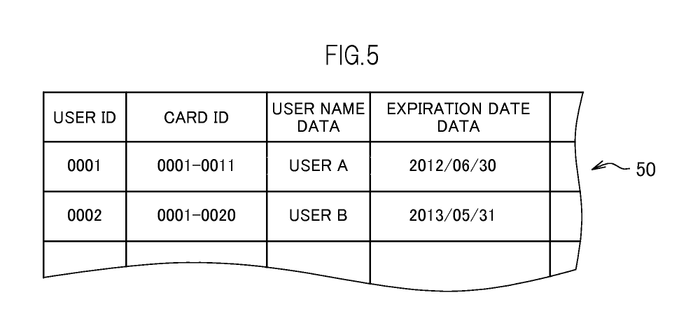

On the sales management system 10 according to this embodiment, account registration processing for users using credit cards has been finished in advance. Then, the user management data storage section 30 stores user management data 50 exemplified in FIG. 5. The user management data 50 includes, for example, user IDs, each of which is an identifier of a user, card IDs, each of which is an identifier of a credit card held by the user, user name data, each of which represents a name of the user, and expiration date data, each of which represents an expiration date of the credit card held by the user.

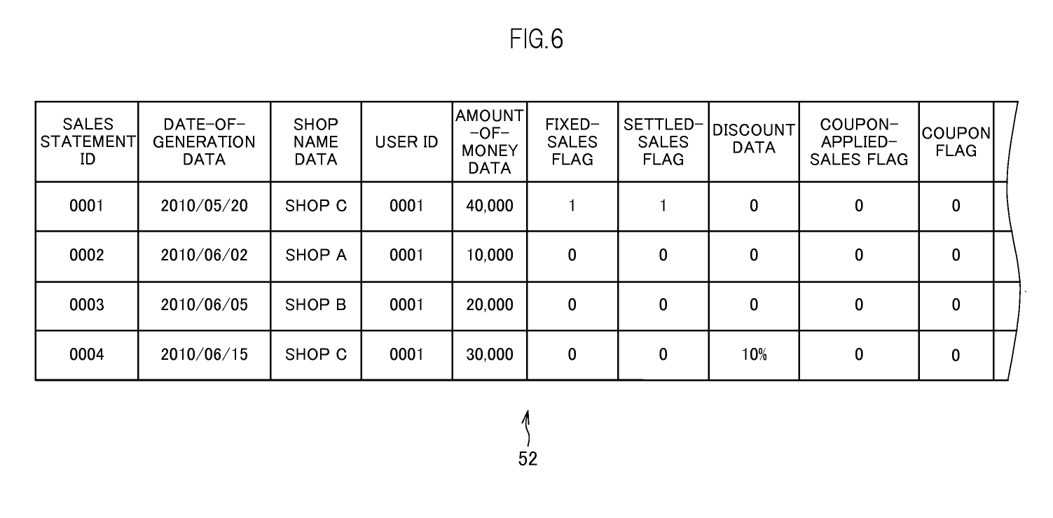

In FIG. 4, the sales statement information generation section 32 receives, according to this embodiment, for example, sales data transmitted from the shop terminals 14, and generates, based on the received sales data, sales statement information 52 exemplified in FIG. 6. Then, the sales statement information generation section 32 outputs the generated sales statement information 52 to the sales statement information storage section 34. The sales statement information 52 includes, for example, sales statement IDs, each of which is an identifier of a sales statement, date-of-generation data, each piece of which represents a date of generation of a sale, shop name data, each piece of which represents a name of a shop in which the sale has been generated, user IDs, each of which is a user ID of a user who has used a credit card, amount-of-money data, each piece of which represents an amount of money paid by the credit card (corresponding to an amount of money of sales at the shop), fixed-sales flags, each of which represents whether or not the sale by the credit card is fixed, settled-sales flags, each of which represents whether or not the sale by the credit card is settled, discount data, each piece of which represents a discount rate or a discount amount of money by a coupon for the amount of money paid by the credit card, coupon-applied-sales flags, each of which represents whether or not the coupon is applied, and coupon flags, each of which represents whether or not the statement is generated based on the coupon.

The sales management system 10 according to this embodiment, an amount of money of a sale is treated as an amount of money in a “temporary fixed state” when the sale is generated. Then, the sales statement information generation section 32 sets 0 as values of the fixed-sales flag and the settled-sales flag of the corresponding sales statement information 52. Then, the sale after a predetermined fixing date is treated as a sale in a “fixed state”, and the sales statement information generation section 32 updates the value of the fixed-sales flag of the corresponding sales statement information 52 to 1.

Then, when a predetermined payment date is reached, the sales management system 10 executes processing of transferring an amount of money to be paid in this month out of the fixed amount of money of sales from a payment account registered in advance to the sales management system 10, and the sale is then treated as a sale in a “settled state”. On this occasion, the sales statement information generation section 32 updates the value of the settled-sales flag of the corresponding sales statement information 52 to 1.

In FIG. 4, according to this embodiment, the access history confirmation section 36 refers, for example, at a predetermined time interval (such as during daily batch processing), to access history information 22 stored in the access history storage section of the shop introduction system 12. The access history confirmation section 36 transmits to the shop introduction system 12, specifically, for example, a query request to confirm whether or not access history information 22 on a user who has used a credit card corresponding to a coupon code display page 20 corresponding to a shop corresponding to shop name data contained in sales statement information 52 (shop of generation of a sale) after a time and date represented by date-of-generation data contained in the sales statement information 52 (time and date of generation of a sale) is stored in the access history storage section of the shop introduction system 12. Then, the shop introduction system 12 transmits to the sales management system 10, in response to the query request, under the condition that the condition described above is confirmed, a value of a discount rate or a discount amount contained in the coupon code display page 20 corresponding to the access history information 22 (a discount rate or a discount amount corresponding to the coupon code display page 20). Then, the access history confirmation section 36 of the sales management system 10 receives the value, and sets the value as the value of the discount data of the corresponding sales statement information 52.

In this way, the access history confirmation section 36 sets, under the condition that it is confirmed that a user who used a credit card has browsed a coupon code display page 20 corresponding to a shop of generation of a sale after a time and date of generation of the sale, a value of a discount rate or a discount amount corresponding to the coupon code display page 20 as the value of the discount data contained in the sales statement information 52.

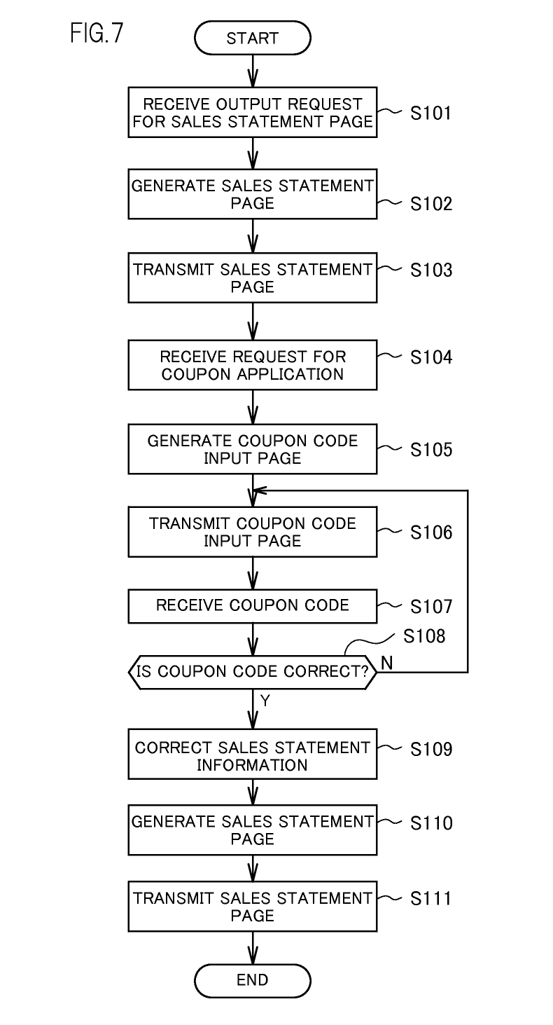

A description is now given of an example of a flow of sales statement information correction processing executed by the sales management system 10 according to this embodiment referring to a flowchart illustrated in FIG. 7. In this processing example, it is confirmed that a user A, who is a user who used a credit card, has browsed a coupon code display page 20 (FIG. 2) for the shop C, which is a shop of generation of a sale, after a time and date of generation of the sale and a value (such as 10%) of the discount data contained in sales statement information 52 corresponding to the sale in the shop C is set.

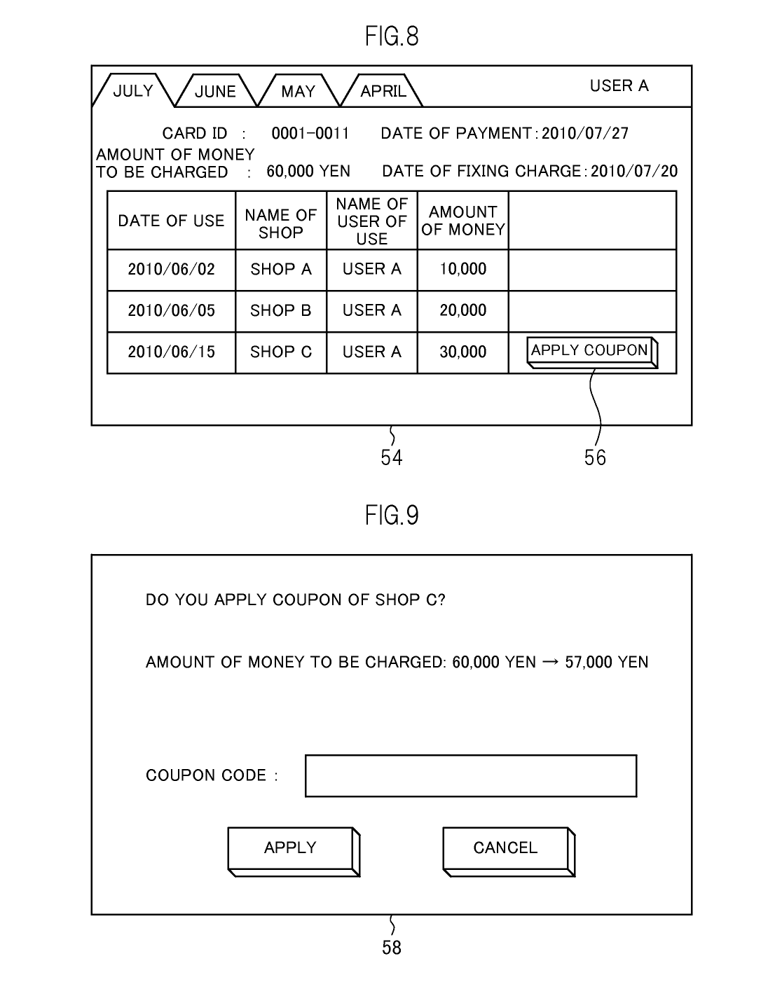

First, the user identification section 38 receives an output request for a sales statement page 54 (refer to FIG. 8) from the user terminal 16 of the user A (S101). On this occasion, the user identification section 38 identifies, based on data received from the user terminal 16 of the user A (for example, a session ID recorded in a cookie file), the user who has made the output request as the user A. Note that, the user identification section 38 may identify the user A by transmitting a log-in page (not shown) to the user terminal 16 as necessary, and receiving, via the log-in page, a pair of a user ID and a password from the user terminal 16.

Then, the statement page generation section 40 generates, based on the sales statement information 52 on the user A, the sales statement page 54 exemplified in FIG. 8 (S102). The sales statement page 54 shows, for example, a card ID, an amount of charge of money (amount of money to be charged) for a corresponding month, a date of payment, date of fixing charge, and a sales statement as a list per month. The sales statement page 54 exemplified in FIG. 8 shows a sales statement for July corresponding to the latest month, which is a sales statement not fixed yet.

The statement page generation section 40 calculates, for example, based on the sales statement information 52 for June for the user A, an amount of money to be charged for July, and places the amount of money to be charged for July in the sales statement page 54. Moreover, the statement page generation section 40 places, for example, for sales statement information 52 in which the value of the discount data is set (for example, the value of the discount data is not 0), a coupon application button 56 at a position corresponding to the sales statement. For example, the statement page generation section 40 places, in a row describing a sales statement at the shop C dated Jun. 15, 2010 in the sales statement page 54, the coupon application button 56.

Then, the statement page transmission section 42 transmits data representing the sales statement page 54 to the user terminal 16 of the user A (S103). Then, the user terminal 16 of the user A receives this data, and outputs the sales statement page 54 via the browser for display on the display.

Then, under the condition that the user A clicks the coupon application button 56 on the sales statement page 54, the user terminal 16 of the user A transmits a request for the application of the coupon to the corresponding sales statement to the sales management system 10. Then, the user identification section 38 of the sales management system 10 receives the coupon application request (S104).

Then, the coupon code input page generation section 44 generates a coupon code input page 58 exemplified in FIG. 9 (S105). On the coupon code input page 58, for example, information for prompting application of the coupon, an amount of money to be charged before the discount, an amount of money to be charged after the discount, a coupon code input form, an application button, and a cancel button are arranged.

The coupon code input page generation section 44 determines, in the processing in S105, for example, based on the sales statement information 52, a discount amount (such as 30,000 yen×10%=3,000 yen). Then, the coupon code input page generation section 44 arranges, in the coupon code input page 58, the amount of money to be charged before the discount, and the amount of money to be charged after the discount which is obtained by subtracting the discount amount from the amount of money to be charged before the discount.

Then, the coupon code input page transmission section 46 transmits data representing the coupon code input page 58 to the user terminal 16 of the user A (S106). Then, the user terminal 16 of the user A receives this data, and outputs the coupon code input page 58 via the browser for display on the display.

Then, under the condition that the user A inputs the coupon code displayed on the coupon code display page 20 (FIG. 2), which the user A has accessed in advance, in the coupon code input page 58, and then clicks the application button, the user terminal 16 of the user A transmits the coupon code to the sales management system 10. Then, the amount of payment correction section 48 of the sales management system 10 receives the coupon code (S107).

Then, the amount of payment correction section 48 verifies whether or not the coupon code is correct (S108). The amount of payment correction section 48 transmits, for example, a confirmation associated with the coupon code asking whether or not the coupon code is correct to the shop introduction system 12. Then, the shop introduction system 12 verifies whether or not the coupon code is the coupon code displayed on the coupon code display page 20, and transmits data representing whether or not the coupon code is correct to the sales management system 10. Then, the amount of payment correction section 48 of the sales management system 10 receives the data, and verifies, based on the received data, whether or not the coupon code is correct.

Under the condition that the coupon code is not correct (N in S108), the sales management system 10 executes again the processing subsequent to the processing in S106.

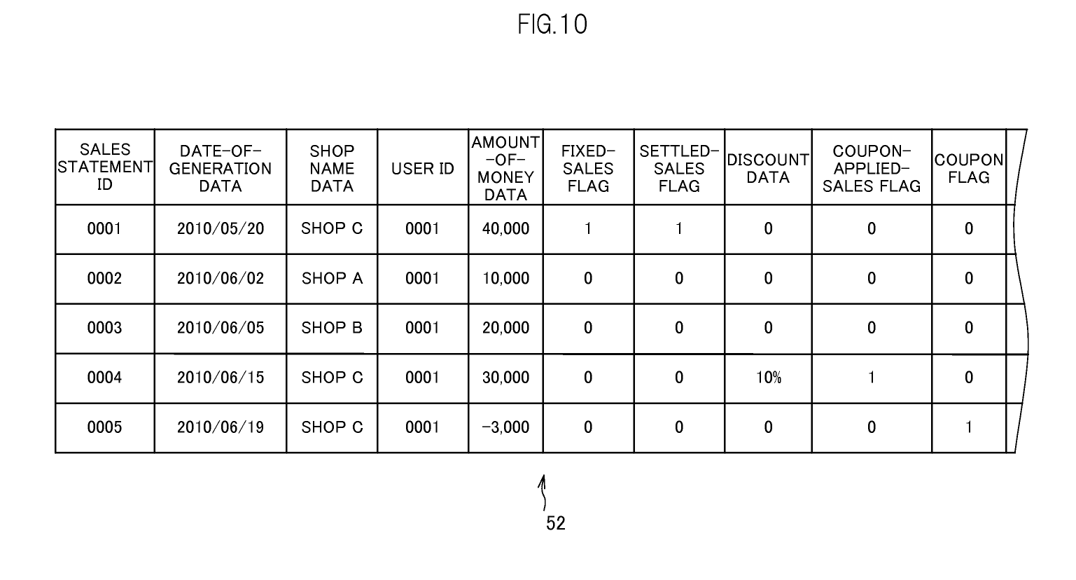

Under the condition that the coupon code is correct (Y in S108), the amount of payment correction section 48 corrects the sales statement information 52 (S109). FIG. 10 illustrates an example of the sales statement information 52 after the correction. The amount of payment correction section 48 specifically, for example, sets the value of the coupon-applied-sales flag contained in the sales statement information 52 to which the coupon has been applied to 1, and generates a new record corresponding to the discount amount (−3,000 yen). Note that, the amount of payment correction section 48 sets, in order to indicate that the new record is a record generated by the coupon application, the value of the coupon flag to 1. In this way, the amount of payment correction section 48 makes correction to reduce the amount of money to be subsequently paid by the user A in the sales statement information 52.

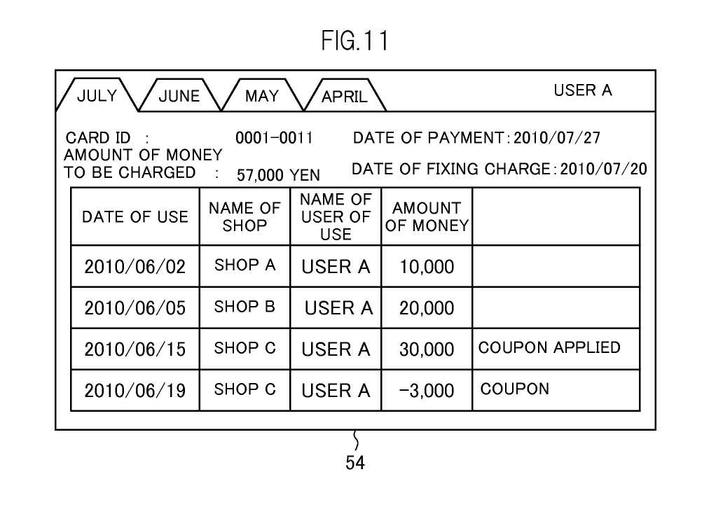

Then, the statement page generation section 40 generates, based on the sales statement information 52 after the correction for the user A, the sales statement page 54 after the correction exemplified in FIG. 11 (S110). The statement page generation section 40 calculates again, for example, based on the sales statement information 52 for June for the user A, the amount of money to be charged (amount of money to be charged after the discount) for July, and places the amount of money to be charged for July in the sales statement page 54. Moreover, the statement page generation section 40 places, for example, at a location corresponding to the record having the value of 1 as the coupon-applied-sales flag, a description representing that the coupon has been applied. Moreover, the statement page generation section 40 places, for example, at a location corresponding to the record generated based on the coupon application (namely, the record having the value of 1 as the coupon flag), a description representing that the information is based on the coupon.

Then, the statement page transmission section 42 transmits data representing the sales statement page 54 after the correction to the user terminal 16 of the user A (S111). Then, the user terminal 16 of the user A receives this data, and outputs the sales statement page 54 via the browser for display on the display, and finishes the processing illustrated in this processing example.

Note that, in the above-mentioned processing example, in the processing in S108, under the condition that it is confirmed that the coupon code is correct (Y in S108), the amount of payment correction section 48 may transmit data representing a coupon application confirmation screen (not shown) containing an OK button to the user terminal 16 of the user A. Then, the user terminal 16 of the user A may output the coupon application confirmation screen for display on the display. Then, under the condition that the user A clicks the OK button on the coupon application confirmation screen, the user terminal 16 of the user A may notify the sales management system 10 of the effect that the application of the coupon is confirmed. Then, under the condition that the sales management system 10 receives the effect that the application of the coupon is confirmed, the sales management system 10 may execute the processing subsequent to the processing in S109.

Moreover, in the above-mentioned processing example, in the processing in S103, in association with the data representing the sales statement page 54, a pop-up instruction for prompting the correction of the amount of money to be charged may be transmitted to the user terminal 16 of the user A. Then, the user terminal 16 of the user A receives the data, outputs the sales statement page 54 for display on the display, and outputs a pop-up alert message for prompting the correction of the amount of money to be charged for display on the display.

Moreover, in the above-mentioned processing example, in the processing in S104, after the reception of the coupon application request from the user terminal 16 of the user A, the amount of payment correction section 48 may transmit data representing the coupon application confirmation screen (not shown) containing the OK button to the user terminal 16 of the user A. Then, the user terminal 16 of the user A may output the coupon application confirmation screen for display on the display. Then, under the condition that the user A clicks the OK button on the coupon application confirmation screen, the user terminal 16 of the user A may notify the sales management system 10 of the effect that the application of the coupon is confirmed. Then, under the condition that the sales management system 10 receives the effect that the application of the coupon is confirmed, the sales management system 10 may skip the processing in S105 to S108 (processing of determining whether or not the coupon code is correct), and may immediately execute the processing subsequent to the processing in S109. In this case, the user A can receive, without inputting the coupon code, the discount service for the amount of money to be charged (in this processing example, the 10% discount service for the amount of money of purchase at the shop C).

According to the processing in this processing example, after the user A performs shopping by using the credit card at the shop C, under the condition that the user A makes an access to the coupon code display page 20 (FIG. 2) of the shop introduction system 12 from the user terminal 16, and then makes an access to the sales statement page 54 (FIG. 8) of the sales management system 10, in the sales statement page 54, the coupon application button 56 associated with the sales statement corresponding to the shopping at the shop C is displayed. On this occasion, under the condition that the user A, on the user terminal 16, clicks the coupon application button 56, and enters the coupon code, the coupon is applied and the discount service for the amount of money to be charged (in this processing example, the 10% discount service for the amount of money of purchase at the shop C) can be received.

In this embodiment, even after a user has used the credit card, under the condition that the user acquires a coupon code from a coupon code display page 20 including the coupon code, and enters the coupon code in the sales statement page 54, the user can receive the discount service. In this way, according to this embodiment, a chance of correction made by a user to the amount of money to be paid increases. Moreover, according to this embodiment, a possibility that a user fails to receive the discount service decreases. Moreover, from this fact, it is expected that a frequency of use of a credit card by a user, a frequency of an access to the shop introduction system 12, and a frequency of use of the sales management system 10 increase.

Note that, the present invention is not limited to the above-mentioned embodiment.

For example, an applicable period may be set to a coupon. Specifically, for example, the storage unit of the shop introduction system 12 may store a value of a discount rate or a discount amount of a coupon and an applicable period data representing an applicable period of the coupon which are associated with each other. Then, the shop introduction system 12 may transmit, in response to a query from the access history confirmation section 36, the value of the discount rate or the discount amount associated with the applicable period data to the sales management system 10. Then, the access history confirmation section 36 of the sales management system 10 may associate the received applicable period data with the sales statement information 52. Then, the statement page generation section 40 may place, under the condition that a time and date of reception of the output request for the sales statement page 54 is within the period represented by the value of the data representing the applicable period, the coupon application button 56 on the sales statement page 54.

Moreover, for example, the access history confirmation section 36 may set, under the condition that access history information 22 on a coupon code display page 20 corresponding to a shop of generation of a sale before a time and date of generation of the sale is confirmed, as the value of the discount data, a predetermined discount rate or a predetermined discount amount. As a result of this configuration, even under the condition that a user has browsed a Web page including a coupon, but forgets to print the Web page and visits a shop, an amount of money of payment can be corrected (for example, a discount service can be received).

Moreover, the amount of payment correction section 48 may make correction, by an amount of money determined based on a time when a user makes an access to a coupon code display page 20 corresponding to a shop of generation of a sale, to reduce an amount of money to be paid by the user. For example, the access history confirmation section 36 may set, as the value of the discount data contained in the sales statement information 52, under the condition that it is confirmed that a user has browsed a coupon code display page 20 corresponding to a shop of generation of a sale, a value of a discount amount or a discount rate determined based on a time and date (time and date of an access) represented by access time and date information contained in the access history information 22 on the coupon code display page 20 corresponding to the shop of generation of the sale. The access history confirmation section 36 may set, for example, as the value of the discount data contained in the sales statement information 52, 15% under the condition that the time and date of an access is earlier than the time and date of generation of a sale, and the difference therebetween is more than two days, 10% under the condition that the time and date of an access is earlier than the time and date of generation of the sale, and the difference therebetween is less than two days, 5% under the condition that the time and date of generation of a sale is earlier than the time and date of an access, and the difference therebetween is less than two days, and 2% under the condition that the time and date of generation of the sale is earlier than the time and date of an access, and the difference therebetween is equal to or more than two days. Then, the amount of payment correction section 48 may make correction, under the condition that a user inputs a correct coupon code, by an amount of money corresponding to the discount amount or the discount rate set as the value of the discount data, to reduce an amount of money to be subsequently paid by the user. Moreover, as described above, in the sales management system 10 according to this embodiment, as the time of an access to a coupon code display page 20 becomes later, the discount amount and the discount rate may decrease.

Moreover, the access history confirmation section 36 may set, as the value of discount data contained in the sales statement information 52, for example, 15% under the condition that a user takes a predetermined action (such as, at a shop of generation of a sale, presenting a hard copy of a coupon code display page 20, or, at a shop of generation of the sale, telling the shop of generation of the sale about the browsing of the coupon code display page 20) (in this case, always before the time and date of generation of the sale, the coupon code display page 20 for the shop of generation of a sale has been browsed by the user), 10% under the condition that, before the time and date of generation of the sale, the user browsed the coupon code display page 20 of the shop of generation of the sale, and the user does not take the predetermined action, 5% under the condition that the user browses, during a period from the time and date of generation of the sale until when the amount of money of sales is treated as an amount of money of sales in the “temporary fixed state”, the coupon code display page 20 of the shop of generation of the sale, and 2% under the condition that the user browses, during a period when the amount of money of sales is treated as an amount of money of sales in the “temporary fixed state”, the coupon code display page 20 of the shop of generation of the sale. Then, the amount of payment correction section 48 may make correction, under the condition that a user inputs a correct coupon code, by an amount of money corresponding to the discount amount or the discount rate set as the value of the discount data, to reduce an amount of money to be subsequently paid by the user. In this way, in the sales management system 10 according to this embodiment, compared with a case where a user takes a predetermined action, the discount amount and the discount rate in the case where the user does not take the predetermined action may be reduced. As a result, for example, a user who does not take the predetermined action, which is an essential condition for the coupon application, can subsequently be saved up to a certain degree.

Moreover, for example, depending on a type of an article or a service for which a user uses a credit card, a time and date of the use, a shop at which the credit card is used, and the like, discount rates and discount amounts different from each other may be set. In other words, the amount of payment correction section 48 may make correction to reduce an amount of money corresponding to a discount rate or a discount amount determined depending on a type of an article or a service for which a user uses a credit card, a time and date of the use, a shop at which the credit card is used, and the like, from an amount of money to be subsequently paid by the user.

Moreover, for example, the amount of payment correction section 48 may, instead of making correction to reduce individual pieces of sales statement information 52, make correction to reduce a total amount of money to be charged for this month determined by the sales statement information 52 based on a predetermined discount rate or discount amount.

Moreover, for example, the statement page generation section 40 may place, in the sales statement page 54, an amount of money to be charged for this month after the reduction as a result of coupon application. Moreover, for example, the statement page generation section 40 may place, in the sales statement page 54, an amount of money to be reduced as a result of coupon application.

Moreover, for example, a coupon code may be data corresponding to information only available at a real shop at which a user has used a credit card. More specifically, for example, in a real shop, a shop clerk may tell a coupon code to a user. Moreover, for example, in a real shop, a poster or the like including a coupon code may be displayed. Further, after use of a credit card, the sales management system 10 may transmit a coupon code, in a form of electronic mail, to the user terminal 16 of the user A.

Moreover, for example, the access history confirmation section 36 may set, regardless of absence/presence of access history information 22 to a coupon code display page 20 corresponding to a shop of generation of a sale, a discount rate or a discount amount of a coupon applicable to a sale corresponding to the shop as the value of the coupon discount data. According to this configuration, even under the condition that access history to the coupon code display page 20 by the user A cannot be confirmed (for example, the user A has not browsed the coupon code display page 20, or a coupon code display page 20 is not originally provided), as long as the coupon code is correct, the reduction service for an amount of money to be charged (in this processing example, 10% discount service for an amount of money of purchase at the shop C) can be provided.

Moreover, the role assignment for the sales management system 10, the shop introduction system 12, the shop terminal 14, and the user terminal 16 is not limited to that of the above-mentioned embodiment. Moreover, the above-mentioned specific numerical values and character strings, and the specific numerical values and character strings in the drawings are examples, and numerical values and character strings are not limited to those numerical values and character strings.

1.-10. (canceled)

11. A sales management system, comprising:
sales statement information storage means for storing sales statement information representing a sale by use of a credit card held by a user;
user identification means for identifying the user based on data received from a user terminal; and
amount of payment correction means for correcting, in a case where conditions that access history to a predetermined site by the user identified by the user identification means is stored in access history storage means for storing the access history to the predetermined site, that a sale by the user which satisfies a specified condition specified in the predetermined site is stored in the sales statement information storage means, and that after the sale which satisfies the specified condition specified in the predetermined site is generated, an output request for a sales statement page is received from the user terminal of the user are satisfied, an amount of money to be paid subsequently by the user in the sales statement information.

12. The sales management system according to claim 11, wherein the amount of payment correction means corrects, in the case where the conditions that the access history to the predetermined site by the user identified by the user identification means is stored in the access history storage means, that the sale by the user which satisfies the specified condition specified in the predetermined site is stored in the sales statement information storage means, and that after the sale which satisfies the specified condition specified in the predetermined site is generated, the output request for the sales statement page is received from the user terminal are satisfied, under a condition that a correction request for the amount of money to be paid is received from the user terminal, the amount of money to be paid subsequently by the user in the sales statement information.

13. The sales management system according to claim 11, wherein the amount of payment correction means corrects, in a case where a time of an access to the predetermined site is after a time point at which the sale which satisfies the specified condition is generated, the amount of money to be paid subsequently by the user in the sales statement information.

14. The sales management system according to claim 11, wherein the amount of payment correction means corrects, in a case where a time of an access to the predetermined site is before a time point at which the sale which satisfies the specified condition is generated, the amount of money to be paid subsequently by the user in the sales statement information.

15. The sales management system according to claim 13, wherein the amount of payment correction means corrects, by an amount of money determined based on a time of the access to the predetermined site by the user, the amount of money to be paid subsequently by the user in the sales statement information.

16. The sales management system according to claim 15, wherein the corrected amount of money to be paid subsequently decreases as the time of the access to the predetermined site by the user becomes later.

17. The sales management system according to claim 11, wherein:
the predetermined site is associated with a discount rate or a discount amount; and
the amount of payment correction means corrects to reduce, based on the discount rate or the discount amount associated with the predetermined site to which it is determined that the access history by the user identified by the user identification means is stored, the amount of money to be paid subsequently by the user.

18. A method of managing sales, comprising:
a step of storing sales statement information representing a sale by use of a credit card held by a user in sales statement information storage means;
a user identification step of identifying the user based on data received from a user terminal; and
an amount of payment correction step of correcting, in a case where conditions that access history to a predetermined site by the user identified in the user identification step is stored in access history storage means for storing the access history to the predetermined site, that a sale by the user which satisfies a specified condition specified in the predetermined site is stored in the sales statement information storage means, and that after the sale which satisfies the specified condition specified in the predetermined site is generated, an output request for a sales statement page is received from the user terminal of the user are satisfied, an amount of money to be paid subsequently by the user in the sales statement information.

19. A recording medium having recorded thereon a program for causing a computer to function as:
means for storing sales statement information representing a sale by use of a credit card held by a user to sales statement information storage means;
user identification means for identifying the user based on data received from a user terminal; and
amount of payment correction means for correcting, in a case where conditions that access history to a predetermined site by the user identified by the user identification means is stored in access history storage means for storing the access history to the predetermined site, that a sale by the user which satisfies a specified condition specified in the predetermined site is stored in the sales statement information storage means, and that after the sale which satisfies the specified condition specified in the predetermined site is generated, an output request for a sales statement page is received from the user terminal of the user are satisfied, an amount of money to be paid subsequently by the user in the sales statement information.

20. The sales management system according to claim 12, wherein the amount of payment correction means corrects, in a case where a time of an access to the predetermined site is after a time point at which the sale which satisfies the specified condition is generated, the amount of money to be paid subsequently by the user in the sales statement information.

21. The sales management system according to claim 20, wherein the amount of payment correction means corrects, by an amount of money determined based on a time of the access to the predetermined site by the user, the amount of money to be paid subsequently by the user in the sales statement information.

22. The sales management system according to claim 21, wherein the corrected amount of money to be paid subsequently decreases as the time of the access to the predetermined site by the user becomes later.

23. The sales management system according to claim 12, wherein the amount of payment correction means corrects, in a case where a time of an access to the predetermined site is before a time point at which the sale which satisfies the specified condition is generated, the amount of money to be paid subsequently by the user in the sales statement information.

24. The sales management system according to claim 23, wherein the amount of payment correction means corrects, by an amount of money determined based on a time of the access to the predetermined site by the user, the amount of money to be paid subsequently by the user in the sales statement information.

25. The sales management system according to claim 13, wherein the amount of payment correction means corrects, in a case where a time of an access to the predetermined site is before a time point at which the sale which satisfies the specified condition is generated, the amount of money to be paid subsequently by the user in the sales statement information.

26. The sales management system according to claim 25, wherein the amount of payment correction means corrects, by an amount of money determined based on a time of the access to the predetermined site by the user, the amount of money to be paid subsequently by the user in the sales statement information.

27. The sales management system according to claim 20, wherein the amount of payment correction means corrects, in a case where a time of an access to the predetermined site is before a time point at which the sale which satisfies the specified condition is generated, the amount of money to be paid subsequently by the user in the sales statement information.

28. The sales management system according to claim 27, wherein the amount of payment correction means corrects, by an amount of money determined based on a time of the access to the predetermined site by the user, the amount of money to be paid subsequently by the user in the sales statement information.

29. The sales management system according to claim 14, wherein the amount of payment correction means corrects, by an amount of money determined based on a time of the access to the predetermined site by the user, the amount of money to be paid subsequently by the user in the sales statement information.

30. The sales management system according to claim 29, wherein the corrected amount of money to be paid subsequently decreases as the time of the access to the predetermined site by the user becomes later.
